(19) United States
(12) Patent Application Publication
(10) Pub. No.: US 2025/0074794 A1
(43) Pub. Date: Mar. 6, 2025

(54) COUNTERTOP WATER DISPENSING SYSTEM

(71) Applicant: Ningbo eastpure environmental technology co., Ltd, Cixi (CN)

(72) Inventor: Yanfeng Xu, Anji County (CN)

(21) Appl. No.: 18/242,548

(22) Filed: Sep. 6, 2023

(51) Int. Cl. C02F 1/44; C02F 1/00; C02F 9/00

(52) U.S. Cl. CPC C02F 1/441; C02F 1/003; C02F 9/00; C02F 2209/005; C02F 2307/10

(57) ABSTRACT

A countertop water dispensing system includes a base; a raw water tank detachably arranged on the base and including a water outlet and a water inlet; a water purification tank detachably arranged on the base and including a water outlet and a water inlet; a filter system provided between the raw water tank and the water purification tank and formed by connecting a reverse osmosis (RO) membrane composite filter element and an activated carbon fiber filter element in series, a water inlet, a first-stage purification water outlet, and a waste water outlet of the RO membrane composite filter element being communicated respectively with the water outlet of the raw water tank, a water inlet of the activated carbon fiber filter element, and the raw water tank; and a pump provided on a pipeline communicating the water inlet and the water outlet of the raw water tank.

### TECHNICAL FIELD

The present disclosure relates to a countertop water dispensing system, belonging to the technical field of water purification and heating devices.

### BACKGROUND

The water dispenser is a device that can provide users with drinking water instantly, and has gradually become one of necessary household appliances in every family. There are many types of water dispensers, and the countertop water dispenser is the most common one. The countertop water dispenser is generally placed on a coffee table, a dining table, a sideboard, etc.

The U.S. patents US2016355425A1 with a publication date of Dec. 8, 2016 and U.S. Pat. No. 10,532,941B2 with a publication date of Jan. 14, 2020 disclose a point-of-use countertop water filtration system, including: a support base; a first receptacle detachably disposed on the support base and configured to store raw water, the first receptacle including an outlet port and an inlet port; a second receptacle detachably disposed on the support base and configured to store supply water, the second receptacle including an inlet port; and a filter system disposed between the first receptacle and the second receptacle, the filter system including an inlet port, a first outlet port, and a second outlet port, a first filter including a sediment filter or a combination of a sediment filter and a carbon filter, a second filter including a reverse osmosis membrane, and a third filter including a carbon filter, where the first filter is configured and disposed to receive water from the inlet port of the filter system and to filter and deliver first filtered water to the second filter, where the second filter is configured and disposed to receive the first filtered water from the first filter, to deliver a first portion of the first filtered water to the first outlet port of the filter system, the first portion of the first filtered water being waste water that is delivered back to the first receptacle, and to filter and deliver a second portion of the first filtered water, the second portion of the first filtered water being second filtered water, where the third filter is disposed between the second filter and the second receptacle and is configured to receive the second filtered water from the second filter and to filter and deliver third filtered water to the second outlet port of the filter system; and where when the first and second receptacles are attached to the support base, the outlet port of the first receptacle is disposed in fluid communication with the inlet port of the filter system, the first outlet port of the filter system is disposed in fluid communication with the inlet port of the filter system, and the inlet port of the first receptacle and the second outlet port of the filter system are disposed in fluid communication with the inlet port of the second receptacle. The point-of-use countertop water filtration system has the following defects: three stages of filters: a first filter, a second filter, and a third filter are employed, such that the structure is complicated, the mounting volume is larger, the replacement cost is higher, etc. The present disclosure aims to provide a countertop water dispensing system with a more optimized structure and easy to achieve industrialization. The system can not only meet the needs of various water use scenarios, but also ensure the safety of users. In terms of mounting, the costs of replacement and maintenance are low.

### SUMMARY

The present disclosure aims to solve the deficiencies of the point-of-use countertop water filtration system in the prior art, and provide a countertop water dispensing system. The system can not only meet the needs of various water use scenarios, but also ensure the safety of users. In terms of mounting, the costs of replacement and maintenance are low.

In order to solve the above technical problems, the present disclosure adopts the following technical solutions:

A countertop water dispensing system is provided, including:
a base;
a raw water tank detachably arranged on the base and configured to store raw water, where the raw water tank includes a water outlet and a water inlet;
a water purification tank detachably arranged on the base and configured to store purified water, where the water purification tank includes a water outlet and a water inlet;
a filter system provided between the raw water tank and the water purification tank, where the filter system is formed by connecting a reverse osmosis (RO) membrane composite filter element and an activated carbon fiber filter element in series, a water inlet of the RO membrane composite filter element is communicated with the water outlet of the raw water tank, a first-stage purification water outlet of the RO membrane composite filter element is communicated with a water inlet of the activated carbon fiber filter element, a waste water outlet of the RO membrane composite filter element is communicated with the raw water tank, and a water outlet of the activated carbon fiber filter element is communicated with the water inlet of the water purification tank; and
a pump provided on a pipeline communicating the water inlet of the RO membrane composite filter element and the water outlet of the raw water tank.

In this embodiment, the raw water tank is communicated with an external water source, and raw water is supplemented intermittently or continuously. The raw water in the raw water tank is pressurized by the pump and enters the RO membrane composite filter element to realize RO filtration. The filtered water enters the activated carbon fiber filter element and is filtered again. After the filtration is completed, the filtered water enters the water purification tank for storage. Later, according to the needs, a cooling module may be provided to obtain cold drinking water, or a heating module may be provided to obtain hot drinking water, etc.

Preferably, a cavity of the raw water tank is divided into a first chamber and a second chamber independent of each other, the first chamber is configured to store the raw water, the second chamber is configured to store waste water, the water outlet and the water inlet of the raw water tank are disposed in the first chamber, a waste water inlet of the raw water tank is disposed in the second chamber, and the waste water outlet of the RO membrane composite filter element is communicated with the waste water inlet of the raw water tank.

Preferably, the RO membrane composite filter element includes a central tube and a filter membrane layer wound on the central tube, the filter membrane layer is formed by stacking a carbon fiber layer, an isolation layer, and a RO membrane layer in sequence, and the raw water sequentially flows through the carbon fiber layer, the isolation layer, and the RO membrane layer to obtain first-stage purification water, which is directed to the central tube. This integrated composite filter element has a compact structure and a smaller volume, and can meet the needs of different application scenarios.

Preferably, the isolation layer is made of one or more of a non-woven fabric, PE, or PP.

Preferably, the raw water tank further includes a lid body, and the lid body is used to open and close a top of the raw water tank; and the water purification tank further includes a control valve, the control valve provides one inlet and two outlets, and a waste water solenoid valve is further provided on a waste water path to control a backflow amount of the waste water.

Preferably, the countertop water dispensing system further includes a front panel assembly, the base includes a raw water tank base, a pump assembly seat, and a water purification tank assembly seat, the front panel assembly and the base form a housing of the countertop water dispensing system, the filter system is disposed in the housing, the front panel assembly is provided with a water outlet nozzle, and the water outlet nozzle is communicated with the water outlet of the water purification tank.

Preferably, the countertop water dispensing system further includes a water storage tray assembly, where the water storage tray assembly is fixed to the front panel assembly and configured to accumulate water dripping from the water outlet nozzle.

Preferably, a solenoid valve is provided on a water path communicating the water outlet nozzle and the water outlet of the water purification tank.

Preferably, the countertop water dispensing system further includes a controller and a switch, where the pump, the switch, and the solenoid valve are all electrically connected to the controller, and the pump is started by starting the controller to control operation and water discharge of the countertop water dispensing system.

Preferably, the controller is provided with a remote wireless communication module communicating with a remote server and a user terminal, the controller has a processor function and integrates at least one Microcontroller Unit (MCU), the MCU controls operation of an assembly electrically connected to the MCU, and the remote wireless communication module is any one or a combination of two of a 2G module, a 3G module, a 4G module, and a 5G module.

The present disclosure has the beneficial effects that the countertop water dispensing system has a more optimized structure and is easy to achieve industrialization. The system can not only meet the needs of various water use scenarios, but also ensure the safety of users. In terms of mounting, the costs of replacement and maintenance are low. The RO membrane composite filter element includes a central tube and a filter membrane layer wound on the central tube, the filter membrane layer is formed by stacking a carbon fiber layer, an isolation layer, and a RO membrane layer in sequence, and the raw water sequentially flows through the carbon fiber layer, the isolation layer, and the RO membrane layer to obtain first-stage purification water, which is directed to the central tube. This integrated composite filter element has a compact structure and a smaller volume, and can meet the needs of different application scenarios.

### BRIEF DESCRIPTION OF THE DRAWINGS

FIG. 1 is a schematic structural diagram of the present disclosure; and

FIG. 2 is a schematic structural diagram of the present disclosure.

Reference Numerals: 1. Raw water tank, 2. Water purification tank, 3. Reverse osmosis (RO) membrane composite filter element, 31. Filter membrane layer, 31a. Carbon fiber layer, 31b. Isolation layer, 31c. RO membrane layer, 32. Central tube, 4. Activated carbon fiber filter element, 5. Pump, 6. Waste water solenoid valve, 7. Front panel assembly, 8. Raw water tank base, 9. Pump assembly seat, 10. Water storage tray assembly, and 11. Lid body.

### DETAILED DESCRIPTION OF THE EMBODIMENTS

The technical solution of the present disclosure is further specifically described below through specific embodiments with reference to the accompanying drawings.

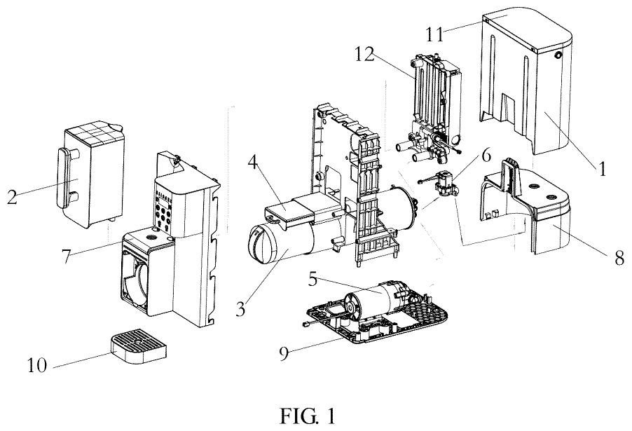

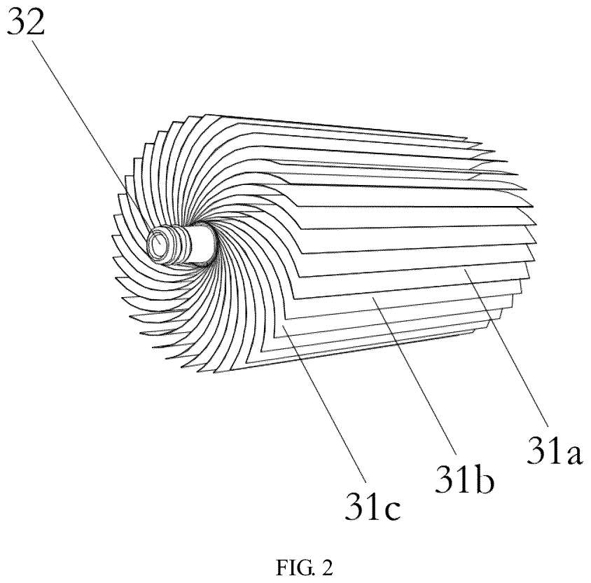

As shown in FIG. 1 and FIG. 2, the countertop water dispensing system includes:
a base;
a raw water tank 1 detachably arranged on the base and configured to store raw water, where the raw water tank 1 includes a water outlet and a water inlet;
a water purification tank 2 detachably arranged on the base and configured to store purified water, where the water purification tank 2 includes a water outlet and a water inlet, and the water outlet and the water inlet are capable of being integrated together to achieve water inlet and outlet functions;
a filter system provided between the raw water tank 1 and the water purification tank 2, where the filter system is formed by connecting a reverse osmosis (RO) membrane composite filter element 3 and an activated carbon fiber filter element 4 in series, a water inlet of the RO membrane composite filter element 3 is communicated with the water outlet of the raw water tank 1, a first-stage purification water outlet of the RO membrane composite filter element 3 is communicated with a water inlet of the activated carbon fiber filter element 4, a waste water outlet of the RO membrane composite filter element 3 is communicated with the raw water tank 1, and a water outlet of the activated carbon fiber filter element 4 is communicated with the water inlet of the water purification tank 2; and a pump 5 provided on a pipeline communicating the water inlet of the RO membrane composite filter element 3 and the water outlet of the raw water tank 1.

In this embodiment, the raw water tank 1 is communicated with an external water source, and raw water is supplemented intermittently or continuously. The raw water in the raw water tank 1 is pressurized by the pump 5 and enters the RO membrane composite filter element 3 to realize RO filtration. The filtered water enters the activated carbon fiber filter element 4 and is filtered again. After the filtration is completed, the filtered water enters the water purification tank 2 for storage. Later, according to the needs, a cooling module may be provided to obtain cold drinking water, or a heating module may be provided to obtain hot drinking water, etc.

In this embodiment, a cavity of the raw water tank 1 is divided into a first chamber and a second chamber independent of each other, the first chamber is configured to store the raw water, the second chamber is configured to store waste water, the water outlet and the water inlet of the raw water tank 1 are disposed in the first chamber, a waste water inlet of the raw water tank 1 is disposed in the second chamber, and the waste water outlet of the RO membrane composite filter element 3 is communicated with the waste water inlet of the raw water tank 1.

In this embodiment, the RO membrane composite filter element 3 is highly integrated, overcoming the defect that three groups of filters are provided in the background art. The functions of the first filter and the second filter can be achieved through one filter. The RO membrane composite filter element 3 includes a central tube 32 and a filter membrane layer 31 wound on the central tube, the filter membrane layer 31 is formed by stacking a carbon fiber layer 31a, an isolation layer 31b, and a RO membrane layer 31c in sequence, and the raw water sequentially flows through the carbon fiber layer 31a, the isolation layer 31b, and the RO membrane layer 31c to obtain first-stage purification water, which is directed to the central tube 32. This integrated composite filter element has a compact structure and a smaller volume, and can meet the needs of different application scenarios.

In this embodiment, the isolation layer 31b is made of one or more of a non-woven fabric, PE, or PP.

In addition, the raw water tank 1 further includes a lid body 11, and the lid body 11 is used to open and close a top of the raw water tank 1; and the water purification tank 2 further includes a control valve, the control valve provides one inlet and two outlets, and a waste water solenoid valve 6 is further provided on a waste water path to control a backflow amount of the waste water.

In this embodiment, the countertop water dispensing system further includes a front panel assembly 7, the base includes a raw water tank base 8, a pump assembly seat 9, and a water purification tank assembly seat, the front panel assembly 7 and the base form a housing of the countertop water dispensing system, the filter system is disposed in the housing, the front panel assembly 7 is provided with a water outlet nozzle, and the water outlet nozzle is communicated with the water outlet of the water purification tank 2. The countertop water dispensing system further includes a water storage tray assembly 10, where the water storage tray assembly 10 is fixed to the front panel assembly 7 and configured to accumulate water dripping from the water outlet nozzle. A solenoid valve is provided on a water path communicating the water outlet nozzle and the water outlet of the water purification tank 2.

The solution of this embodiment can implement automatic control of a countertop water dispenser. To achieve the function of automatic control, the countertop water dispensing system further includes a controller and a switch, where the pump 5, the switch, and the solenoid valve are all electrically connected to the controller, and the pump 5 is started by starting the controller to control operation and water discharge of the countertop water dispensing system.

The application of Internet of Things technology is the technological development trend of product intelligence. With this regard, in this embodiment, the controller is provided with a remote wireless communication module communicating with a remote server and a user terminal, the controller has a processor function and integrates at least one MCU, the MCU controls operation of an assembly electrically connected to the MCU, and the remote wireless communication module is any one or a combination of two of a 2G module, a 3G module, a 4G module, and a 5G module.

The present disclosure has the beneficial effects that the countertop water dispensing system has a more optimized structure and is easy to achieve industrialization. The system can not only meet the needs of various water use scenarios, but also ensure the safety of users. In terms of mounting, the costs of replacement and maintenance are low. The RO membrane composite filter element 3 includes a central tube 32 and a filter membrane layer 31 wound on the central tube 32, the filter membrane layer 31 is formed by stacking a carbon fiber layer 31a, an isolation layer 31b, and a RO membrane layer 31c in sequence, and the raw water sequentially flows through the carbon fiber layer 31a, the isolation layer 31b, and the RO membrane layer 31c to obtain first-stage purification water, which is directed to the central tube 32. This integrated composite filter element has a compact structure and a smaller volume, and can meet the needs of different application scenarios.

The above examples are merely preferred solutions of the present disclosure and are not intended to limit the present disclosure in any form, and other variations and modifications may be made without departing from the technical solutions of the present disclosure as set forth in the appended claims.

What is claimed is:

1. A countertop water dispensing system, comprising:
a base;
a raw water tank detachably arranged on the base and configured to store raw water, wherein the raw water tank comprises a water outlet and a water inlet;
a water purification tank detachably arranged on the base and configured to store purified water, wherein the water purification tank comprises a water outlet and a water inlet;
a filter system provided between the raw water tank and the water purification tank, wherein the filter system is formed by connecting a reverse osmosis (RO) membrane composite filter element and an activated carbon fiber filter element in series, a water inlet of the RO membrane composite filter element is communicated with the water outlet of the raw water tank, a first-stage purification water outlet of the RO membrane composite filter element is communicated with a water inlet of the activated carbon fiber filter element, a waste water outlet of the RO membrane composite filter element is communicated with the raw water tank, and a water outlet of the activated carbon fiber filter element is communicated with the water inlet of the water purification tank; and
a pump provided on a pipeline communicating the water inlet of the RO membrane composite filter element and the water outlet of the raw water tank.

2. The countertop water dispensing system according to claim 1, wherein a cavity of the raw water tank is divided into a first chamber and a second chamber independent of each other, the first chamber is configured to store the raw water, the second chamber is configured to store waste water, the water outlet and the water inlet of the raw water tank are disposed in the first chamber, a waste water inlet of the raw water tank is disposed in the second chamber, and the waste water outlet of the RO membrane composite filter element is communicated with the waste water inlet of the raw water tank.

3. The countertop water dispensing system according to claim 2, wherein the RO membrane composite filter element comprises a central tube and a filter membrane layer wound on the central tube, the filter membrane layer is formed by stacking a carbon fiber layer, an isolation layer, and a RO membrane layer in sequence, and the raw water sequentially flows through the carbon fiber layer, the isolation layer, and the RO membrane layer to obtain first-stage purification water, which is directed to the central tube.

4. The countertop water dispensing system according to claim 3, wherein the isolation layer is made of one or more of a non-woven fabric, PE, or PP.

5. The countertop water dispensing system according to claim 1, wherein the raw water tank further comprises a lid body, and the lid body is used to open and close a top of the raw water tank; and the water purification tank further comprises a control valve, the control valve provides one inlet and two outlets, and a waste water solenoid valve is further provided on a waste water path to control a backflow amount of the waste water.

6. The countertop water dispensing system according to claim 1, further comprising a front panel assembly, wherein the base comprises a raw water tank base, a pump assembly seat, and a water purification tank assembly seat, the front panel assembly and the base form a housing of the countertop water dispensing system, the filter system is disposed in the housing, the front panel assembly is provided with a water outlet nozzle, and the water outlet nozzle is communicated with the water outlet of the water purification tank.

7. The countertop water dispensing system according to claim 6, further comprising a water storage tray assembly, wherein the water storage tray assembly is fixed to the front panel assembly and configured to accumulate water dripping from the water outlet nozzle.

8. The countertop water dispensing system according to claim 6, wherein a solenoid valve is provided on a water path communicating the water outlet nozzle and the water outlet of the water purification tank.

9. The countertop water dispensing system according to claim 8, further comprising a controller and a switch, wherein the pump, the switch, and the solenoid valve are all electrically connected to the controller, and the pump is started by starting the controller to control operation and water discharge of the countertop water dispensing system.

10. The countertop water dispensing system according to claim 9, wherein the controller is provided with a remote wireless communication module communicating with a remote server and a user terminal, the controller has a processor function and integrates at least one Microcontroller Unit (MCU), the MCU controls operation of an assembly electrically connected to the MCU, and the remote wireless communication module is any one or a combination of two of a 2G module, a 3G module, a 4G module, and a 5G module.
